(19) United States
(12) Patent Application Publication
(10) Pub. No.: US 2023/0274551 A1
(43) Pub. Date: Aug. 31, 2023

(54) IMAGE-SURVEILLED SECURITY ESCORT

(71) Applicant: Johnson Controls Tyco IP Holdings LLP, Milwaukee, WI (US)

(72) Inventor: Matthew JULIEN, Milwaukee, WI (US)

(21) Appl. No.: 17/681,458

(22) Filed: Feb. 25, 2022

(51) Int. Cl. G06V 20/52; G06V 10/70; G01C 21/34

(52) U.S. Cl. CPC G06V 20/52; G01C 21/3407; G06V 10/70

(57) ABSTRACT

Example implementations include a method, apparatus, and computer-readable medium comprising receiving, by a computing device, a request for providing image-surveilled security escort for a user to reach a destination; determining, by the computing device, whether a security event is detected in image-surveilled data associated with the destination; and providing, by the computing device, a notification indicative of whether the security event is detected in the image-surveilled data associated with the destination.

### FIELD

The present disclosure relates generally to security systems and methods, and more specifically, to image-surveilled security systems and methods.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method comprising receiving, by a computing device, a request for providing image-surveilled security escort for a user to reach a destination. The method further includes determining, by the computing device, whether a security event is detected in image-surveilled data associated with the destination. The method further includes providing, by the computing device, a notification indicative of whether the security event is detected in the image-surveilled data associated with the destination.

Another example implementation includes an apparatus comprising a memory and a processor communicatively coupled with the memory. The processor is configured to receive a request for providing image-surveilled security escort for a user to reach a destination. The processor is further configured to determine whether a security event is detected in image-surveilled data associated with the destination. The processor is further configured to provide a notification indicative of whether the security event is detected in the image-surveilled data associated with the destination.

A further example implementation includes an apparatus comprising means for receiving, by a computing device, a request for providing image-surveilled security escort for a user to reach a destination. The apparatus further includes means for determining, by the computing device, whether a security event is detected in image-surveilled data associated with the destination. The apparatus further includes means for providing, by the computing device, a notification indicative of whether the security event is detected in the image-surveilled data associated with the destination.

Another example implementation includes a computer-readable medium storing instructions executable by a processor. The instructions, when executed, cause the processor to receive a request for providing image-surveilled security escort for a user to reach a destination. The instructions, when executed, further cause the processor to determine whether a security event is detected in image-surveilled data associated with the destination. The instructions, when executed, further cause the processor to provide a notification indicative of whether the security event is detected in the image-surveilled data associated with the destination.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example system for image-surveilled security escort, according to some aspects;

FIG. 2 is a block diagram of an example computing device which may implement all or a portion of any system or component in FIG. 1, according to some aspects;

FIG. 3 is a block diagram of example components of a computing device which may implement all or a portion of any system or component in FIG. 1 configured for image-surveilled security escort, according to some aspects;

FIG. 4 is a flow diagram of an example method of image-surveilled security escort, according to some aspects;

FIG. 5 is a flow diagram of another example method of image-surveilled security escort, according to some aspects; and

FIG. 6 is a flow diagram of a further example method of image-surveilled security escort, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Some present aspects provide automated security escort functionality using one or more image surveillance devices (e.g., cameras). In one non-limiting aspect, for example, an image-surveilled security escort system in a parking lot ensures that a user is notified of any suspicious activity in the vicinity of their parking spot, and optionally monitors the vicinity and sends an alert if a security event occurs while the user is travelling to their vehicle. In an aspect, for example, before exiting a building, the user checks in at a kiosk. In one non-limiting aspect, the kiosk may take a picture of the user to determine their parking spot by matching the user picture to surveillance footage of the parking lot. In another non-limiting aspect, the user may enter their parking spot information (e.g., spot 65) via a user interface on the kiosk. In an aspect, the user interface on the kiosk notifies the user of any unusual activity detected around their vehicle. In an aspect, the user interface on the kiosk may show a path to the vehicle which avoids other people.

In some alternative or additional aspects, some or all of the functionality of the kiosk may be implemented via a user device of the user. For example, the user may have an application (app) installed on their phone, in which case the user may initiate security escort functionality on their user device from their car to the kiosk or to a security checkpoint, e.g., the lobby of a building. Although some of the below aspects are described with reference to a kiosk, these aspects may alternatively or additionally be implemented via an app running on a user device such as a user phone.

In one non-limiting optional aspect, the user interface of the kiosk asks the user if they would like to enroll in a check-in process configured to ensure that the user reaches the parking spot safely. If yes, the user is asked to send a message (e.g., a text message) to an on-screen code / number provided on a user interface of the kiosk. The kiosk also requests a check-in time period from the user. If the check-in time expires without receiving a check-in message from the user, the image-surveilled security escort system may send an alert to a security entity (e.g., a guard at the parking lot), and may optionally provide video footage of the user walking to their vehicle. Alternatively and/or additionally, if the check-in time expires without receiving a check-in message from the user, the image-surveilled security escort system may send an alert to a user device of the user.

Accordingly, in cases where security / operations personnel are limited or unavailable, the image-surveilled security escort system performs complementary / automated site safety functions. For example, many people may not feel comfortable walking alone to their vehicle or other destination, e.g., walking alone in a parking lot at night. The image-surveilled security escort system according to the present aspects ensures that the user reaches their vehicle / destination safely and notifies the user of suspicious activities detected near where they parked. Therefore, the image-surveilled security escort system may make the user feel safer when traveling to their parking spot. Further, just the presence of the image-surveilled security escort system and just the visiting of the kiosk before exiting the building may also act as a deterrent to prevent attackers / stalkers from following a user to their vehicle.

Turning now to the figures, example aspects are depicted with reference to one or more components described herein, where components in dashed lines may be optional.

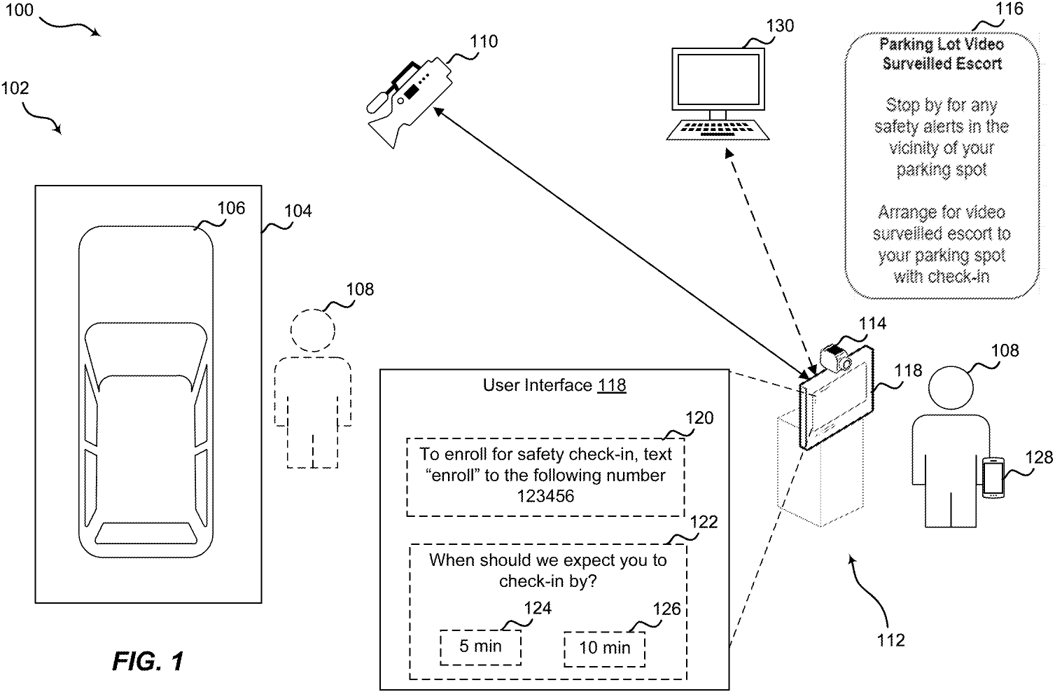

Referring to FIG. 1, an image-surveilled security escort system 100 includes a kiosk 112 configured for providing image-surveilled security escort to a user 108 that has parked their vehicle 106 at a parking spot 104 in a parking lot 102 surveilled by one or more security cameras 110. A sign 116 may be posted at the kiosk 112 to inform the user 108 about the functionality provided by the image-surveilled security escort system 100 through the kiosk 112, so that before returning to the vehicle 106, the user 108 may stop by the kiosk 112 to obtain safety information and/or arrange for automated image-surveilled security escort to the vehicle 106. For example, the sign 116 may read: “Parking Lot Video Surveilled Escort. Stop by for any safety alerts in the vicinity of your parking spot. Arrange for video surveilled escort to your parking spot with check-in.”

In one non-limiting aspect, upon visiting the kiosk 112, a camera 114 in the kiosk 112 takes a picture of the user 108. Alternatively, a user device 128 of the user 108 (e.g., a user cell phone) may implement some or all of the functionality of the kiosk 112. For example, if the user 108 is a daily parker at the parking lot 102, the user device 128 may take an image of the user 108, etc. Further details of the various example aspects are described below.

In one non-limiting aspect, the image-surveilled security escort system 100 looks up the parking spot 104 of the vehicle 106 of the user 108 based on detection of the user 108 in previous video footage of the parking lot 102. The image-surveilled security escort system 100 then performs anomaly detection on the area around the parking spot 104, and the user 108 is presented with safety details / risk level on a user interface 118 of the kiosk 112. For example, the user interface 118 may indicate that there is another vehicle next to the parking spot 104 and no one exited that vehicle, people are lingering nearby the parking spot 104, unusual people poses are detected near the parking spot 104 (e.g., people ducking, people laying on the ground, etc.), etc.

In one non-limiting aspect, the image-surveilled security escort system 100 provides an option for the user 108 to enroll in a safety check-in process. For example, the user interface 118 of the kiosk 112 may display a first message 120 indicating: “To enroll for safety check-in, text “enroll” to the following number 123456.” The user 108 may then use a user device 128 (e.g., a mobile device) to text “enroll” to the number indicated in the first message 120, e.g., send a text message to “123456.” Once the text message is received by the image-surveilled security escort system 100 (e.g., via a backhaul network), the user interface 118 of the kiosk 112 may display a second message 122 indicating: “When should we expect you to check in by?” In one non-limiting aspect, for example, the user interface 118 of the kiosk 112 may also provide a first selection 124 for the user 108 to select to check in in 5 minutes and a second selection 126 for the user 108 to select to check in in 10 minutes.

Subsequently, if the user 108 does not check in by the selected time, the image-surveilled security escort system 100 determines that the check-in time has expired. In this case, the image-surveilled security escort system 100 may send an alarm / notification to a security entity 130. Along with the alarm / notification, the image-surveilled security escort system 100 may also send video footage of the user 108 walking to the parking spot 104 in the parking lot 102. In one non-limiting aspect, for example, the security entity 130 may be a guard desk / security operations and may include monitors for displaying the alarm / notification and/or the video footage of the user 108.

Further details of the present aspects are described below.

In one non-limiting aspect, when the user 108 visits the kiosk 112 and the camera 114 in the kiosk 112 takes a picture of the user 108, the image-surveilled security escort system 100 searches the video footage of the parking lot 102 as captured by the security camera(s) 110 to automatically determine the parking spot 104 of the user 108 by matching the picture of the user 108 with the video footage. In an aspect, the image-surveilled security escort system 100 may use machine learning to perform the matching. In some alternative aspects, the image-surveilled security escort system 100 may identify the parking spot 104 based on information stored in a user profile associated with the user 108. For example, the user 108 may be pre-registered with the image-surveilled security escort system 100, in which case the image-surveilled security escort system 100 may recognize the user 108 by performing facial recognition on the picture of the user 108. Alternatively, the user 108 may identify themselves to the image-surveilled security escort system 100 by entering a passcode via the user interface 118, by scanning a quick response (QR) code via a scanner in the kiosk 112, etc.

In some non-limiting aspects, in order to prevent potential safety risks, the image-surveilled security escort system 100 may use one or more trained models that are trained to detect any unusual activity around the parking spot 104 and/or in a path from a current location of the user 108 (e.g., from the kiosk 112) to the parking spot 104. The image-surveilled security escort system 100 may then notify the user 108 (e.g., via the user interface 118 of the kiosk 112) of potential safety risks as detected in the video footage of the parking lot 102. If unusual activity has been detected in the video footage of the parking lot 102, the image-surveilled security escort system 100 may also display the video footage related to the unusual activity to the user 108 on the user interface 118 of the kiosk 112.

The user 108 may then choose to contact security personnel (or others) to arrange for a physical / personal escort to the parking spot 104. However, the image-surveilled security escort system 100 may also prompt the user 108 (e.g., via the user interface 118 of the kiosk 112) to indicate whether the user 108 would like to enroll in a check-in process. If the user 108 answers yes to participate in the check-in process, the user 108 is presented with a code or number to send a text message to enroll in the check-in process. If the user 108 sends the text message to the code or number, the image-surveilled security escort system 100 asks the user 108 to provide a check-in time and directs the user 108 to send the text message to the image-surveilled security escort system 100 prior to this time, so that the image-surveilled security escort system 100 knows that the user 108 safely reached the vehicle 106.

As described above, in some non-limiting aspects, the user interface 118 may provide the first selection 124 for the user 108 to select to check in in 5 minutes and the second selection 126 for the user 108 to select to check in in 10 minutes. However, the present aspects are not so limited. For example, in some alternative or additional aspects, an input field may be provided on the user interface 118 of the kiosk 112 for the user 108 to enter a user-defined numeric value for the check-in time. In some other alternative or additional aspects, a frictionless input may be received from the user 108, for example, via a QR code, etc.

If the user 108 does not check in within the check-in time, the image-surveilled security escort system 100 may alert a security entity 130 (such as security personnel). Along with the alert, the image-surveilled security escort system 100 may also send further information / relevant data. For example, in some aspects, the image-surveilled security escort system 100 may gather / bundle relevant data that may be useful in case the user 108 does not check in. The relevant data may include, for example, the picture of the user 108, a video footage of the user 108 walking to the vehicle 106, a phone number associated with the user 108, license plate information of the vehicle 106 (e.g., if captured by the security cameras 110 or if available in user profile of the user 108), etc. If the user 108 does not check in in time, the image-surveilled security escort system 100 may send an alarm as well as any of the above relevant data to the security entity 130. In response, the security entity 130 (or operations personnel) may review the video footage and determine whether or not a critical safety situation exists, may call the user 108, may physically go to assist the user 108 in person, and/or may notify law enforcement of any issues.

In some alternative or additional aspects, if the user 108 does not check in in time, the image-surveilled security escort system 100 may change an environmental condition in the parking lot 102 and/or around the parking spot 104 to improve safety and/or deter criminals. For example, the image-surveilled security escort system 100 may turn on additional lighting, may activate an audible or visual alarm near the parking spot 104, etc.

In some alternative or additional aspects, the image-surveilled security escort system 100 may monitor the video footage of the parking lot 102 to determine whether the user 108 reaches the vehicle 106. If the video footage does not indicate that the user 108 has reached the vehicle 106, the image-surveilled security escort system 100 may analyze the video footage to determine where the user 108 is and/or if the user 108 is facing a safety issue. If a distress situation is detected, the image-surveilled security escort system 100 may send an alarm as well as any relevant data to the security entity 130.

In some aspects, the image-surveilled security escort system 100 may identify potential safety issues based on crime statistics / safety recommendations. However, there may be some situations that are of interest to an individual traveling to their vehicle, but such situations may not necessarily raise any red flags for a team monitoring an entire property. Accordingly, in some alternative or additional aspects, the image-surveilled security escort system 100 may identify potential safety issues by performing video identification of events / situations / objects that have been safety risks to individuals trying to reach their vehicles in the past.

In some non-limiting aspects, the image-surveilled security escort system 100 may continue to provide security information after the user leaves the kiosk 112. For example, in an aspect, if the image-surveilled security escort system 100 detects unusual activity after the user leaves the kiosk 112 and walks toward the vehicle 106, the user 108 may receive further information via the user device 128 (e.g., via an app on a cell phone) as the user 108 is walking toward the vehicle 106 in the parking lot 102.

As described, in some aspects, the image-surveilled security escort system 100 may use a picture of the user 108 taken by the camera 114 in the kiosk 112 to match the user with security footage of the parking lot 102 and identify the user 108 and/or the parking spot 104 of the vehicle 106 of the user 108. However, the present aspects are not so limited. For example, in some alternative or additional aspects, the image-surveilled security escort system 100 may use stored information (e.g., stored in a user profile of the user 108) identifying the parking spot 104 used by the user 108 on a regular basis (e.g., for a daily parker). Alternatively or additionally, the user 108 may explicitly indicate the parking spot 104 to the image-surveilled security escort system 100, for example, by entering an input on the user interface 118 of the kiosk 112.

In some aspects, after the user 108 stops by the kiosk 112 and has their picture taken, the image-surveilled security escort system 100 determines a relevant time period for detecting suspicious activities that are relevant to the safety of the user 108. For example, once the image-surveilled security escort system 100 identifies the user 108 and determines that the user 108 was detected previously in the video footage of the parking lot 102, the image-surveilled security escort system 100 may determine that only the time period between the time the user 108 parked the vehicle 106 at the parking spot 104 and the time the user 108 stops by the kiosk 112 is relevant to the safety of the user 108. Accordingly, the image-surveilled security escort system 100 may perform anomaly detection only on the video footage of the parking lot 102 in the time period that is relevant to the user 108. Analyzing only the relevant time period may result in reduced computational cost associated with video footage analysis.

In some non-limiting aspects, the image-surveilled security escort system 100 may run a counter that indicates, based on a camera feed, how many people are moving in and out of an area. Using this counter, the image-surveilled security escort system 100 may determine if someone is camping in that area. The image-surveilled security escort system 100 may use machine learning on video footage of the area to determine any criminal activity in the area only if the counter indicates a disparity between people in and out of the area. Limiting the analysis of video footage of the area only to those instances where a disparity exists between people in and out of the area may result in reduced computational cost associated with video footage analysis.

In various aspects, some or all of the functionality described herein with reference to the image-surveilled security escort system 100 may be implemented by one or more local servers and/or by one or more remote servers. For example, in some non-limiting aspects, the machine learning, image recognition, and/or video footage analysis performed by the image-surveilled security escort system 100 may be executed by remote servers in a cloud system. In some alternative or additional aspects, any user profiles, historical safety event detection data and alarms, and/or historical video footage of the parking lot 102 may be stored in a cloud storage.

In some non-limiting alternative aspects, the check-in process may be automated. For example, the image-surveilled security escort system 100 may automatically register that the user 108 is checked in when the video footage of the parking lot 102 indicates that the user 108 gets into the vehicle 106 or that the user 108 drives out of the parking spot 104. In these aspects, automatically registering that the user 108 is checked in would also ensure that the user is not abducted. For example, if the image-surveilled security escort system 100 sends a message to the user 108 if they have not responded in a timely manner, the abductor may respond with a message indicating the user 108 arrived safely.

In some aspects, when the image-surveilled security escort system 100 determines (e.g., based on a user check-in which may be automatically done or explicitly done by the user 108) that the user 108 has reached the vehicle 106 in time, the security escort functionality is terminated.

In some non-limiting alternative aspects, the image-surveilled security escort system 100 may not include the kiosk 112, in which case the functionality of the kiosk 112 may be provided via an app on the user device 128 of the user 108. In some aspects, the app may also recognize the location of the user 108 based on the location of the user device 128. For example, the app may recognize whether the user 108 has entered the parking lot 102, whether the user 108 has parked at the parking spot 104, whether the user 108 is returning back to the parking spot 104, etc. Based on the location of the user 108, the app may automatically initiate image-surveilled security escort functionality and/or notify a compute infrastructure associated with the image-surveilled security escort system 100 in the parking lot 102.

In an aspect, for example, when the user 108 parks the vehicle 106 at the parking spot 104, the user 108 may indicate, via the app on the user device 128, that the user 108 has parked the vehicle 106. In this case, the current location of the user device 128 identifies the parking spot 104. Later on, if the location of the user 108 indicates that the user 108 is exiting a building and returning to the parking spot 104, the app may initiate a check-in process to determine whether the user 108 reaches the vehicle 106 in time. Optionally, the app on the user device 128 may suggest a walking path to the parking spot 104. If the user 108 does not reach the parking spot 104 in time, the app may send an alarm to the security entity 130 and/or ask the user 108 to indicate, via the app, whether the user 108 is in danger.

Although the above example aspects are described with reference to safety in a parking lot, the present aspects are not so limited. For example, the present aspects may be implemented to provide a security escort system for traveling from point A to point B, for example, in a college campus. For example, a user may indicate, e.g., via a user interface of a kiosk or via a user interface of a user device, that the user intends to travel from point A to point B. The security escort system may then track the global positioning system (GPS) location of the user device to determine if the user 108 reaches point B in time. In an aspect, if the person deviates off the path from point A to point B, the security escort system may send a notification to a security entity for help. When the system determines (e.g., based on the GPS location of the user device) that the user has reached point B in time, the security escort functionality is terminated.

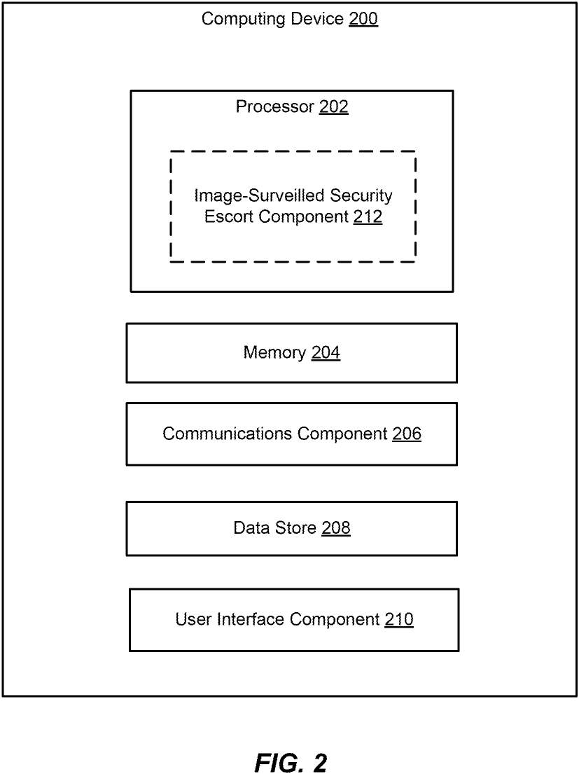

FIG. 2 illustrates an example block diagram providing details of computing components in a computing device 200 that may implement all or a portion of one or more components in an image-surveilled security escort system, a kiosk, a user device, a camera, or any other system or component described above. The computing device 200 includes a processor 202 which may be configured to execute or implement software, hardware, and/or firmware modules that perform any functionality described above with reference to one or more components in an image-surveilled security escort system, a kiosk, a user device, a camera, or any other system or component described above. For example, the processor 202 may be configured to execute an image-surveilled security escort component 212 to provide image-surveilled security escort functionality as described herein with reference to various aspects.

The processor 202 may be a micro-controller and/or may include a single or multiple set of processors or multi-core processors. Moreover, the processor 202 may be implemented as an integrated processing system and/or a distributed processing system. The computing device 200 may further include a memory 204, such as for storing local versions of applications being executed by the processor 202, related instructions, parameters, etc. The memory 204 may include a type of memory usable by a computer, such as random access memory (RAM), read only memory (ROM), tapes, flash drives, magnetic discs, optical discs, volatile memory, non-volatile memory, and any combination thereof. Additionally, the processor 202 and the memory 204 may include and execute an operating system executing on the processor 202, one or more applications, display drivers, etc., and/or other components of the computing device 200.

Further, the computing device 200 may include a communications component 206 that provides for establishing and maintaining communications with one or more other devices, parties, entities, etc., utilizing hardware, software, and services. The communications component 206 may carry communications between components on the computing device 200, as well as between the computing device 200 and external devices, such as devices located across a communications network and/or devices serially or locally connected to the computing device 200. For example, the communications component 206 may include one or more buses, and may further include transmit chain components and receive chain components associated with a wireless or wired transmitter and receiver, respectively, operable for interfacing with external devices.

Additionally, the computing device 200 may include a data store 208, which can be any suitable combination of hardware and/or software, that provides for mass storage of information, databases, and programs. For example, the data store 208 may be or may include a data repository for applications and/or related parameters not currently being executed by processor 202. In addition, the data store 208 may be a data repository for an operating system, application, display driver, etc., executing on the processor 202, and/or one or more other components of the computing device 200.

The computing device 200 may also include a user interface component 210 operable to receive inputs from a user of the computing device 200 and further operable to generate outputs for presentation to the user (e.g., via a display interface to a display device). The user interface component 210 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 210 may include one or more output devices, including but not limited to a display interface, a speaker, a haptic feedback mechanism, a printer, any other mechanism capable of presenting an output to a user, or any combination thereof.

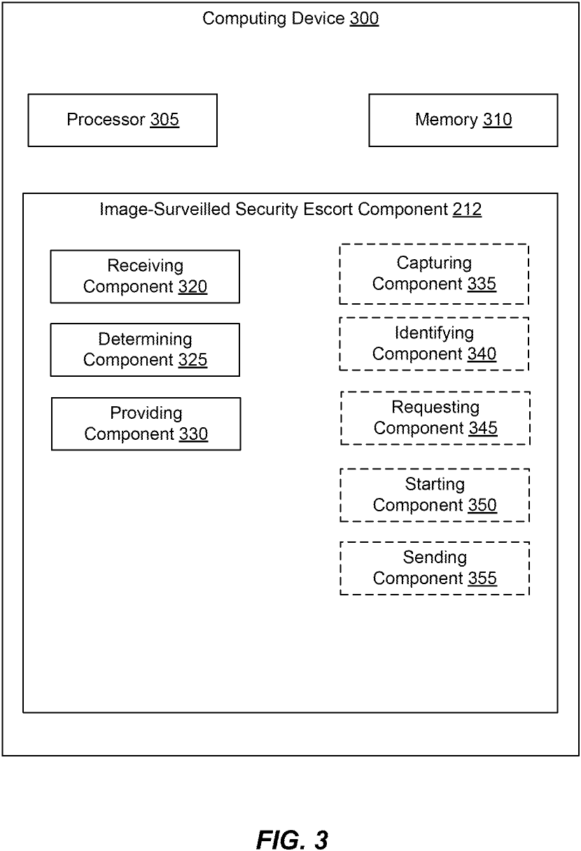

Referring to FIGS. 3-6, in operation for image-surveilled security escort, computing device 300 may implement at least a portion of one or more components in FIGS. 1-2 above, and may perform methods 400, 500, and/or 600 such as via execution of image-surveilled security escort component 212 by processor 305 and/or memory 310. Specifically, computing device 300 may be configured to execute methods 400, 500, and/or 600 for performing various aspects of image-surveilled security escort as described herein. It should be noted that computing device 300, processor 305, and memory 310 may be the same or similar to computing device 200, processor 202, and memory 204 as described above with reference to FIG. 2.

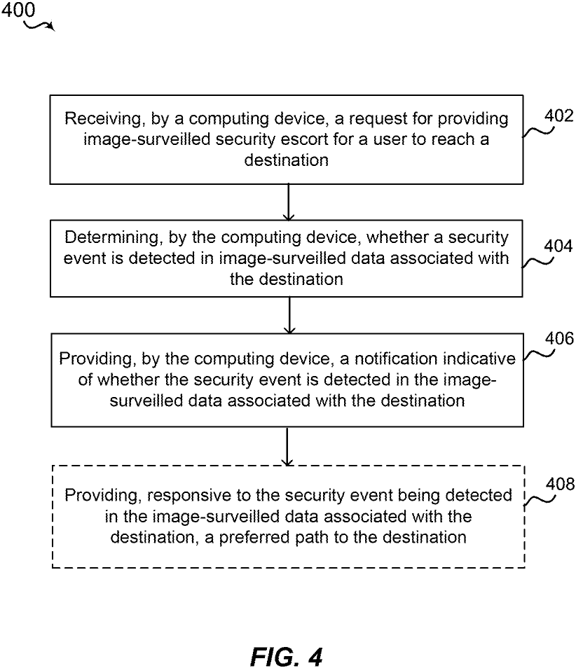

Referring first to FIG. 4, at block 402, the method 400 includes receiving, by a computing device, a request for providing image-surveilled security escort for a user to reach a destination. For example, in an aspect, computing device 300, processor 305, memory 310, image-surveilled security escort component 212, and/or receiving component 320 may be configured to or may comprise means for receiving, by a computing device, a request for providing image-surveilled security escort for a user to reach a destination.

For example, the receiving at block 402 may include the image-surveilled security escort system 100 executing the receiving component 320 to receive, e.g., via the user interface 118 of the kiosk 112, a request for providing image-surveilled security escort for the user 108 to reach a destination.

In some optional implantations, the kiosk 112 at the parking lot 102 where the user 108 has parked the vehicle 106 comprises the computing device.

In some optional implementations, the destination comprises the parking spot 104 in the parking lot 102 where the user 108 has parked the vehicle 106.

At block 404, the method 400 includes determining, by the computing device, whether a security event is detected in image-surveilled data associated with the destination. For example, in an aspect, computing device 300, processor 305, memory 310, image-surveilled security escort component 212, and/or determining component 325 may be configured to or may comprise means for determining, by the computing device, whether a security event is detected in image-surveilled data associated with the destination.

For example, the determining at block 404 may include the image-surveilled security escort system 100 executing the determining component 325 to determine whether a security event is detected in image-surveilled data associated with the parking spot 104 as captured by the security cameras 110 in the parking lot 102.

In some optional implementations, determining whether the security event is detected at block 404 comprises applying machine learning to the image-surveilled data to determine whether the image-surveilled data indicates unusual activity in a vicinity of the parking spot 104.

At block 406, the method 400 includes providing, by the computing device, a notification indicative of whether the security event is detected in the image-surveilled data associated with the destination. For example, in an aspect, computing device 300, processor 305, memory 310, image-surveilled security escort component 212, and/or providing component 330 may be configured to or may comprise means for providing, by the computing device, a notification indicative of whether the security event is detected in the image-surveilled data associated with the destination.

For example, the providing at block 406 may include the image-surveilled security escort system 100 executing the providing component 330 to provide, e.g., via the user interface 118 of the kiosk 112, a notification indicative of whether the security event is detected in the image-surveilled data associated with the parking spot 104 as captured by the security cameras 110 in the parking lot 102 in the path from the kiosk 112 to the parking spot 104.

Optionally, at block 408, the method 400 may include providing, responsive to the security event being detected in the image-surveilled data associated with the destination, a preferred path to the destination. For example, in an aspect, computing device 300, processor 305, memory 310, image-surveilled security escort component 212, and/or providing component 330 may be configured to or may comprise means for providing, responsive to the security event being detected in the image-surveilled data associated with the destination, a preferred path to the destination.

For example, the providing at block 408 may include the image-surveilled security escort system 100 executing the providing component 330 to provide, e.g., via the user interface 118 of the kiosk 112, and responsive to the security event being detected in the image-surveilled data associated with the parking spot 104, a preferred path from the kiosk 112 to the parking spot 104, e.g., to avoid other people or suspicious vehicles (e.g., to avoid a parked car from which no one exited).

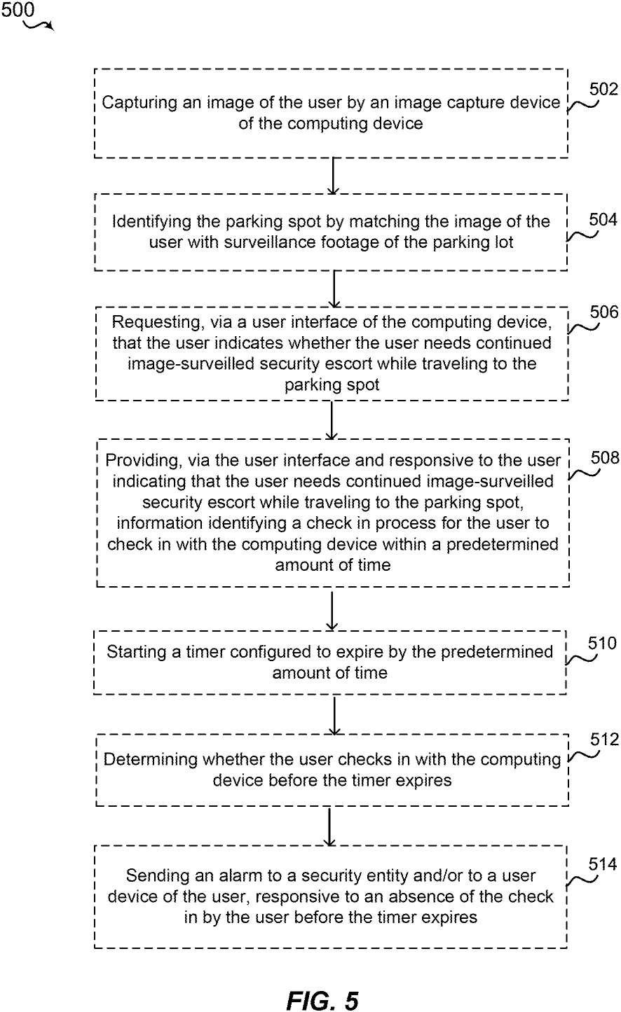

Referring next to FIG. 5, method 500 includes further optional aspects which may be performed in addition to method 400.

At optional block 502, the method 500 may include capturing an image of the user by an image capture device of the computing device. For example, in an aspect, computing device 300, processor 305, memory 310, image-surveilled security escort component 212, and/or capturing component 335 may be configured to or may comprise means for capturing an image of the user by an image capture device of the computing device.

For example, the capturing at block 502 may include the image-surveilled security escort system 100 executing the capturing component 335 to cause the camera 114 in the kiosk 112 to capture an image of the user 108. Alternatively, the user device 128 of the user 108 may capture an image of the user 108 and send the image to the image-surveilled security escort system 100.

Optionally, at block 504, the method 500 may include identifying the parking spot by matching the image of the user with surveillance footage of the parking lot. For example, in an aspect, computing device 300, processor 305, memory 310, image-surveilled security escort component 212, and/or identifying component 340 may be configured to or may comprise means for identifying the parking spot by matching the image of the user with surveillance footage of the parking lot.

For example, the identifying at block 504 may include the image-surveilled security escort system 100 executing the identifying component 340 to identify the parking spot 104 where the user 108 has parked the vehicle 106 by matching the image of the user 108 with surveillance footage of the parking lot 102. Alternatively, the user 108 may enter information identifying the parking spot 104 (e.g., a parking spot number), for example, via the user interface 118 of the kiosk 112 or via an app on the user device 128.

Optionally, at block 506, the method 500 may include requesting, via a user interface of the computing device, that the user indicates whether the user needs continued image-surveilled security escort while traveling to the parking spot. For example, in an aspect, computing device 300, processor 305, memory 310, image-surveilled security escort component 212, and/or requesting component 345 may be configured to or may comprise means for requesting, via a user interface of the computing device, that the user indicates whether the user needs continued image-surveilled security escort while traveling to the parking spot.

For example, the requesting at block 506 may include the image-surveilled security escort system 100 executing the requesting component 345 to request, via the user interface 118 of the kiosk 112 or via an app on the user device 128, that the user 108 indicates whether the user 108 needs continued image-surveilled security escort while traveling from the kiosk 112 to the parking spot 104.

Optionally, at block 508, the method 500 may include providing, via the user interface and responsive to the user indicating that the user needs continued image-surveilled security escort while traveling to the parking spot, information identifying a check-in process for the user to check in with the computing device within a predetermined amount of time. For example, in an aspect, computing device 300, processor 305, memory 310, image-surveilled security escort component 212, and/or providing component 330 may be configured to or may comprise means for providing, via the user interface and responsive to the user indicating that the user needs continued image-surveilled security escort while traveling to the parking spot, information identifying a check-in process for the user to check in with the computing device within a predetermined amount of time.

For example, the providing at block 508 may include the image-surveilled security escort system 100 executing the providing component 330 to provide, via the user interface 118 of the kiosk 112 or via an app on the user device 128, and responsive to the user 108 indicating that the user 108 needs continued image-surveilled security escort while traveling from the kiosk 112 to the parking spot 104, information identifying a check-in process for the user 108 to check in with the image-surveilled security escort system 100 within a predetermined amount of time. In some aspects, the user 108 may respond to a text that was sent by the image-surveilled security escort system 100 to the user device 128 of the user 108 (e.g., the user’s phone). In some aspects, an app on the user device 128 of the user 108 may provide options for checking in. For example, the app on the user device 128 may provide options for clicking on a “good to go” button or “safe” button versus a “help” button.

Optionally, in some implementations, the information provided at block 508 may comprise a number for sending a check-in text to check in with the image-surveilled security escort system 100.

Optionally, in some implementations, the information provided at block 508 may comprise the check-in text and the predetermined amount of time.

Optionally, in some implementations, the providing at block 508 may include the image-surveilled security escort system 100 executing the providing component 330 to request the user 108 to select the predetermined amount of time.

Optionally, at block 510, the method 500 may include starting a timer configured to expire by the predetermined amount of time. For example, in an aspect, computing device 300, processor 305, memory 310, image-surveilled security escort component 212, and/or starting component 350 may be configured to or may comprise means for starting a timer configured to expire by the predetermined amount of time.

For example, the starting at block 510 may include the image-surveilled security escort system 100 executing the starting component 350 to start a timer configured to expire by the predetermined amount of time as indicated in block 508.

Optionally, at block 512, the method 500 may include determining whether the user checks in with the computing device before the timer expires. For example, in an aspect, computing device 300, processor 305, memory 310, image-surveilled security escort component 212, and/or determining component 325 may be configured to or may comprise means for determining whether the user checks in with the computing device before the timer expires.

For example, the determining at block 512 may include the image-surveilled security escort system 100 executing the determining component 325 to determine whether the user 108 checks in with the image-surveilled security escort system 100 before the timer expires.

Optionally, at block 514, the method 500 may include sending an alarm to a security entity and/or to a user device of the user, responsive to an absence of a check-in by the user before the timer expires. For example, in an aspect, computing device 300, processor 305, memory 310, image-surveilled security escort component 212, and/or sending component 335 may be configured to or may comprise means for sending an alarm to a security entity and/or to a user device of the user, responsive to an absence of a check-in by the user before the timer expires.

For example, the sending at block 514 may include the image-surveilled security escort system 100 executing the sending component 355 to send an alarm to the security entity 130 and/or to the user device 128 of the user 108, responsive to an absence of a check-in by the user 108 before the timer expires.

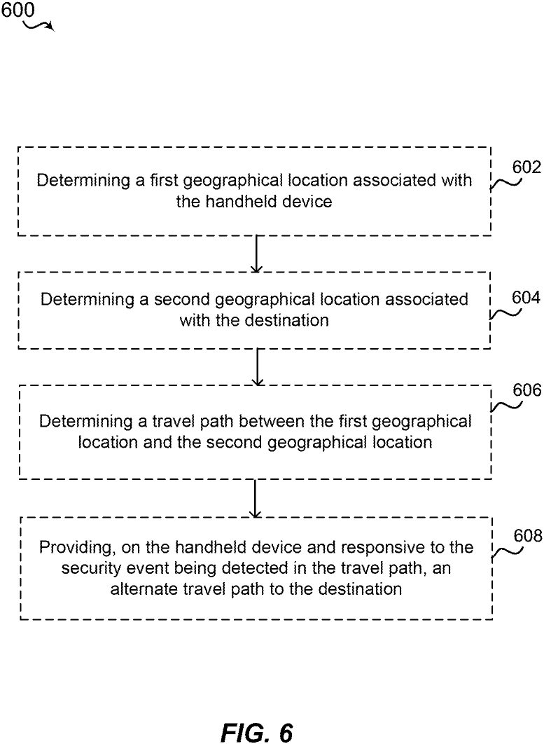

Optionally, in some implantations of the method 400, the computing device comprises the user device 128 associated with the user 108. Some further example optional aspects of these implementations are described below with reference to FIG. 6 and method 600 which may be optionally performed in addition to method 400.

Optionally, at block 602, the method 600 may include determining a first geographical location associated with the user device. For example, in an aspect, computing device 300, processor 305, memory 310, image-surveilled security escort component 212, and/or determining component 325 may be configured to or may comprise means for determining a first geographical location associated with the user device.

For example, the determining at block 602 may include the image-surveilled security escort system 100 executing the determining component 325 to determine a first geographical location associated with the user device 128 of the user 108.

In some optional implementations, the first geographical location is a global positioning system “GPS” location of the user device 128 of the user 108.

Optionally, at block 604, the method 600 may include determining a second geographical location associated with the destination. For example, in an aspect, computing device 300, processor 305, memory 310, image-surveilled security escort component 212, and/or determining component 325 may be configured to or may comprise means for determining a second geographical location associated with the destination.

For example, the determining at block 604 may include the image-surveilled security escort system 100 using the determining component 325 to determine a second geographical location associated with the destination where the user 108 intends to reach. In an example aspect, the destination may be the parking spot 104 at the parking lot 102. In another example aspect, the destination may be a location on a campus. For example, the user 108 may be traveling from a first campus building to a second campus building.

Optionally, at block 606, the method 600 may include determining a travel path between the first geographical location and the second geographical location. For example, in an aspect, computing device 300, processor 305, memory 310, image-surveilled security escort component 212, and/or determining component 325 may be configured to or may comprise means for determining a travel path between the first geographical location and the second geographical location.

For example, the determining at block 606 may include the image-surveilled security escort system 100 using the determining component 325 to determine a travel path between the first geographical location associated with the user device 128 of the user 108 and the second geographical location associated with the destination where the user 108 intends to reach, which may be, for example but not limited to, the parking spot 104 at the parking lot 102.

In some optional implementations, determining whether the security event is detected at block 404 comprises determining whether the security event is detected in the travel path determined at block 606.

Optionally, at block 608, the method 600 may include providing, on the user device and responsive to the security event being detected in the travel path, an alternate travel path to the destination. For example, in an aspect, computing device 300, processor 305, memory 310, image-surveilled security escort component 212, and/or providing component 330 may be configured to or may comprise means for providing, on the user device and responsive to the security event being detected in the travel path, an alternate travel path to the destination.

For example, the providing at block 608 may include the image-surveilled security escort system 100 executing the providing component 330 to provide, on the user device 128 of the user 108 and responsive to the security event being detected in the travel path, an alternate travel path to the destination. For example, in some aspects, if a security event is detected in the travel path between the first geographical location associated with the user device 128 of the user 108 and the second geographical location associated with the parking spot 104 at the parking lot 102, the image-surveilled security escort system 100 may cause the user device 128 to provide / display an alternate / safer travel path between the first geographical location associated with the user device 128 of the user 108 and the second geographical location associated with the parking spot 104 at the parking lot 102. In some aspects, if the user 108 deviates too far from a laid out path, the image-surveilled security escort system 100 may indicate an abduction.

Some further example aspects are provided below.

1. A method comprising:
receiving, by a computing device, a request for providing image-surveilled security escort for a user to reach a destination;
determining, by the computing device, whether a security event is detected in image-surveilled data associated with the destination; and
providing, by the computing device, a notification indicative of whether the security event is detected in the image-surveilled data associated with the destination.

2. The method of clause 1, wherein the destination comprises a parking spot in a parking lot.

3. The method of clause 1 or 2, wherein determining whether the security event is detected comprises applying machine learning to the image-surveilled data to determine whether the image-surveilled data indicates unusual activity in a vicinity of the parking spot.

4. The method of any one of the above clauses, further comprising:
capturing an image of the user by an image capture device of the computing device; and
identifying the parking spot by matching the image of the user with surveillance footage of the parking lot.

5. The method of any one of the above clauses, further comprising:
requesting, via a user interface of the computing device, that the user indicates whether the user needs continued image-surveilled security escort while traveling to the parking spot;
providing, via the user interface and responsive to the user indicating that the user needs continued image-surveilled security escort while traveling to the parking spot, information identifying a check-in process for the user to check in with the computing device within a predetermined amount of time; and
starting a timer configured to expire by the predetermined amount of time.

6. The method of clause 5, wherein the information comprises a number for sending a check-in text to check in with the computing device.

7. The method of clause 5 or 6, wherein the information further comprises the check-in text and the predetermined amount of time.

8. The method of any one of clauses 5 to 7, further comprising requesting the user to select the predetermined amount of time.

9. The method of any one of clauses 5 to 8, further comprising determining whether the user checks in with the computing device before the timer expires.

10. The method of any one of clauses 5 to 9, further comprising sending an alarm to a security entity, responsive to an absence of a check-in by the user before the timer expires.

11. The method of any one of clauses 5 to 10, further comprising sending an alarm to a user device of the user, responsive to an absence of a check-in by the user before the timer expires.

12. The method of clause 1 or 2, wherein the computing device comprises a kiosk at the parking lot.

13. The method of any one of the above clauses, further comprising providing, responsive to the security event being detected in the image-surveilled data associated with the destination, a preferred path to the destination.

14. The method of clause 1, wherein the computing device comprises a user device associated with the user.

15. The method of clause 1 or 14, further comprising:
determining a first geographical location associated with the user device;
determining a second geographical location associated with the destination; and
determining a travel path between the first geographical location and the second geographical location.

16. The method of clause 15, wherein the first geographical location is a global positioning system “GPS” location of the user device.

17. The method of clause 15 or 16, wherein determining whether the security event is detected comprises determining whether the security event is detected in the travel path.

18. The method of any one of clauses 15-17, further comprising providing, on the user device and responsive to the security event being detected in the travel path, an alternate travel path to the destination.

An apparatus comprising:
a memory; and
a processor communicatively coupled with the memory and configured to perform the method of any one of the above clauses.

A non-transitory computer-readable medium storing instructions executable by a processor that, when executed, cause the processor to perform the method of any one of the above clauses.

An apparatus comprising means for performing the method of any one of the above clauses.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
receiving, by a computing device, a request for providing image-surveilled security escort for a user to reach a destination;
determining, by the computing device, whether a security event is detected in image-surveilled data associated with the destination; and
providing, by the computing device, a notification indicative of whether the security event is detected in the image-surveilled data associated with the destination.

2. The method of claim 1, wherein the destination comprises a parking spot in a parking lot.

3. The method of claim 2, wherein determining whether the security event is detected comprises applying machine learning to the image-surveilled data to determine whether the image-surveilled data indicates unusual activity in a vicinity of the parking spot.

4. The method of claim 2, further comprising:
capturing an image of the user by an image capture device of the computing device; and
identifying the parking spot by matching the image of the user with surveillance footage of the parking lot.

5. The method of claim 2, further comprising:
requesting, via a user interface of the computing device, that the user indicates whether the user needs continued image-surveilled security escort while traveling to the parking spot;
providing, via the user interface and responsive to the user indicating that the user needs continued image-surveilled security escort while traveling to the parking spot, information identifying a check-in process for the user to check in with the computing device within a predetermined amount of time; and
starting a timer configured to expire by the predetermined amount of time.

6. The method of claim 5, wherein the information comprises a number for sending a check-in text to check in with the computing device.

7. The method of claim 6, wherein the information further comprises the check-in text and the predetermined amount of time.

8. The method of claim 5, further comprising requesting the user to select the predetermined amount of time.

9. The method of claim 5, further comprising determining whether the user checks in with the computing device before the timer expires.

10. The method of claim 9, further comprising sending an alarm to a security entity, responsive to an absence of a check-in by the user before the timer expires.

11. The method of claim 9, further comprising sending an alarm to a user device of the user, responsive to an absence of a check-in by the user before the timer expires.

12. The method of claim 2, wherein the computing device comprises a kiosk at the parking lot.

13. The method of claim 1, further comprising providing, responsive to the security event being detected in the image-surveilled data associated with the destination, a preferred path to the destination.

14. The method of claim 1, wherein the computing device comprises a user device associated with the user.

15. The method of claim 14, further comprising:
determining a first geographical location associated with the user device;
determining a second geographical location associated with the destination; and
determining a travel path between the first geographical location and the second geographical location.

16. The method of claim 15, wherein the first geographical location is a global positioning system “GPS” location of the user device.

17. The method of claim 15, wherein determining whether the security event is detected comprises determining whether the security event is detected in the travel path.

18. The method of claim 17, further comprising providing, on the user device and responsive to the security event being detected in the travel path, an alternate travel path to the destination.

19. A computing device comprising:
a memory; and
a processor communicatively coupled with the memory and configured to:
receiving, by the computing device, a request for providing image-surveilled security escort for a user to reach a destination;
determine, by the computing device, whether a security event is detected in image-surveilled data associated with the destination; and
provide, by the computing device, a notification indicative of whether the security event is detected in the image-surveilled data associated with the destination.

20. A non-transitory computer-readable medium storing instructions executable by a processor of a computing device, wherein the instructions, when executed, cause to the processor to:
receiving, by the computing device, a request for providing image-surveilled security escort for a user to reach a destination;
determining, by the computing device, whether a security event is detected in image-surveilled data associated with the destination; and
providing, by the computing device, a notification indicative of whether the security event is detected in the image-surveilled data associated with the destination.
